(19) United States
(12) Patent Application Publication
(10) Pub. No.: US 2015/0092467 A1
(43) Pub. Date: Apr. 2, 2015

(54) Driver Circuit for a Pair of Semiconductor Switches in a Leg of a Three-Level Inverter Half-Bridge

(71) Applicant: Infineon Technologies AG, Neubiberg (DE)

(72) Inventor: Raghavan Nagarajan, Soest (DE)

(21) Appl. No.: 14/040,859

(22) Filed: Sep. 30, 2013

(51) Int. Cl. H02M 7/5387

(52) U.S. Cl. CPC H02M 7/53871
USPC 363/132

(57) ABSTRACT

A three-level driver circuit for an inverter half-bridge includes an output inverter half-bridge, which has four switches in series. The switches are controlled by signals from a switch controller applied via gate drivers. Switch delay times are taken into consideration to prevent short-circuiting when dimensioning the switching constellations of the switches.

### FIELD OF TECHNOLOGY

The disclosure relates to a gate driver for a pair of semiconductor switches in a leg of a three-level inverter half-bridge, in particular a three-level inverter half-bridge employed in a power application.

### BACKGROUND

Power converters are commonly used to convert electrical power, for example, from high voltage to low voltage and vice versa, or from alternating current (AC) to direct current (DC) and vice versa. DC-to-DC converters include combinations of DC-to-AC and AC-to-DC converters and may convert, e.g., a relatively low-voltage direct current into a relatively high-voltage direct current or vice versa. Power converters, like many other power circuits, use inverter half-bridges that can be classified as two-level, three-level or multi-level inverter half-bridges. The two-level inverter half-bridge is the simplest type and derives its name from the fact that the voltage at the AC output is switched between two discrete voltage levels, e.g., corresponding to the electrical potentials of the positive and negative DC terminals. When the upper switch in a phase is turned on, the AC output terminal is connected to the positive DC terminal, resulting in an output voltage corresponding to the positive DC potential with respect to the midpoint potential of the converter. Conversely, when the lower of the two switches in the phase is turned on, the AC output terminal is connected to the negative DC terminal, resulting in an output voltage corresponding to the negative DC potential. The two switches corresponding to one phase must never be turned on simultaneously, as this would result in severe damage to the converter. The simplest waveform that can be produced by a two-level converter is a square wave. However, this would produce higher levels of harmonic distortion, which result in high switching losses and high levels of electromagnetic interference. The ability to utilize three levels has the benefit of producing an output voltage with lower harmonic distortion, in addition to providing higher output voltages with lower-voltage-rated power switches.

In an attempt to improve on the poor harmonic performance of two-level inverter half-bridges, three-level and multi-level half-bridges are used, which can synthesize three or more, instead of the two, discrete voltage levels at the AC terminal of each phase corresponding to the positive DC potential, the negative DC potential and the midpoint potential. Three-level half-bridges use four switches whose load paths are connected in series. For example, the top two switches are turned on to obtain a positive output voltage, the bottom two switches are turned on to obtain a negative output voltage and the middle two switches are turned on to obtain similar output voltage.

As can be seen, three-level and multi-level half-bridges need more sophisticated switch control than two-level half-bridges. Therefore, the switch controller commonly generates all four or more signals necessary to control the four or more switches via the respective four or more gate drivers. Gate drivers, as used in power circuits such as converters, are power amplifier circuits with voltage isolation that accept low-power input signals from the switch controller (e.g., a microcontroller, ASIC, etc.) and provide an isolated high-current drive output for the gates of the switches. The switches are, for example, isolated gate bipolar transistors (IGBTs), metal-oxide-semiconductor field-effect transistors (MOSFETs), integrated gate-commutated thyristors (IGCTs), bipolar junction transistors (BJTs) or junction field-effect transistors (JFET) made from any semiconductor materials such as Si, SiC, GaN, GaA, etc. However, generating all switch control signals in the switch controller requires additional design work to be done by the power converter manufacturer; it is hoped that this can be reduced.

### SUMMARY

A gate driver circuit for a pair of transistors in a leg of a three-level inverter half-bridge comprises a driver input configured to receive a two-level input signal that comprises at least one given pulse with a given pulse duration during which the input signal takes on one of the two levels. A first driver output is configured to provide a control signal for one switch of the pair of switches. A second driver output is configured to provide a control signal for the other switch of the pair of switches. A signal processing circuit has one input branch, and two output branches. The input branch is coupled with the driver input, the first output branch is coupled with the first driver output and the second output branch is coupled with the second driver output. The first output branch is configured to provide a two-level output signal that comprises a first pulse with a first pulse duration during which the input signal takes on one of the two levels. The second output branch is configured to provide a two-level output signal that comprises a second pulse with a second pulse duration during which the second output signal takes on one of the two levels. The first length is smaller than or equal to the given length and the second length is smaller than the first length. The second pulse occurs during the occurrence of the first pulse.

A three-level inverter half-bridge has a pair of transistors in each half-bridge leg and two driver circuits connected to the control inputs of the pair of switches. Each pair of transistors comprises a series connection of the load paths of an inner switch connected to an inverter output and an outer switch connected to an inverter supply line. Each of the driver circuits comprises a driver input configured to receive a two-level input signal that comprises at least one given pulse with a given pulse duration during which the input signal takes on one of the two levels; a first driver output configured to provide a control signal for the outer switch of the pair of transistors; a second driver output configured to provide a control signal for the inner switch of the pair of transistors; and a signal processing circuit that has one input branch a first output branch and a second output branch. The input branch is coupled with the driver input, the first output branch is coupled with the first driver output and the second output branch is coupled with the second driver output. The first output branch is configured to provide a two-level output signal that comprises a first pulse with a first pulse duration during which the input signal takes on one of the two levels. The second output branch is configured to provide a two-level output signal that comprises a second pulse with a second pulse duration during which the second output signal takes on one of the two levels. The first length is smaller than or equal to the given length and the second length is smaller than the first length. The second pulse occurs during the occurrence of the first pulse.

Other circuits, methods, features and advantages will be, or will become, apparent to one with skill in the art upon examination of the following figures and detailed description. It is intended that all such additional systems, methods, features and advantages be included within this description, be within the scope of the invention and be protected by the following claims.

### BRIEF DESCRIPTION OF THE DRAWINGS

The circuit may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 is a block diagram illustrating the switching control structure of a three-level inverter half-bridge with four driver signals generated by a control circuit.

FIG. 2 is a block diagram illustrating the switching control structure of a three-level inverter half-bridge with two driver input signals generated by a control circuit and four driver output signals generated by a driver circuit.

FIG. 3 is a diagram illustrating the driver output signals in an inverter half-bridge and the output signal of the inverter half-bridge of FIG. 2 over time.

FIG. 4 is a diagram illustrating the driver input signals of the three-level inverter half-bridge of FIG. 2 over time.

FIG. 5 is a block diagram illustrating the driver circuit for providing two two-level control signals for one leg of a three-level inverter half-bridge from a two-level input signal.

FIG. 6 is a block diagram illustrating a first example of a galvanically isolating signal splitting structure applicable in the gate driver circuit of FIG. 5.

FIG. 7 is a block diagram illustrating a second example of a galvanically isolating signal splitting structure applicable in the gate driver circuit of FIG. 5.

FIG. 8 is a block diagram illustrating a third example of a galvanically isolating signal splitting structure applicable in the gate driver circuit of FIG. 5.

FIG. 9 is a block diagram illustrating a fourth example of a galvanically isolating signal splitting structure applicable in the gate driver circuit of FIG. 5.

FIG. 10 is a block diagram illustrating a fifth example of a galvanically isolating signal splitting structure applicable in the gate driver circuit of FIG. 5.

FIG. 11 is a block diagram illustrating a first example of a signal processing structure applicable in the signal splitting structure of the gate driver circuit of FIG. 5.

FIG. 12 is a block diagram illustrating a second example of a signal processing structure applicable in the signal splitting structure of the gate driver circuit of FIG. 5.

FIG. 13 is a block diagram illustrating a third example of a signal processing structure applicable in the signal splitting structure of the gate driver circuit of FIG. 5.

FIG. 14 is a block diagram illustrating a fourth example of a signal processing structure applicable in the signal splitting structure of the gate driver circuit of FIG. 5.

FIG. 15 is a block diagram illustrating a fifth example of a signal processing structure applicable in the signal splitting structure of the gate driver circuit of FIG. 5.

### DETAILED DESCRIPTION

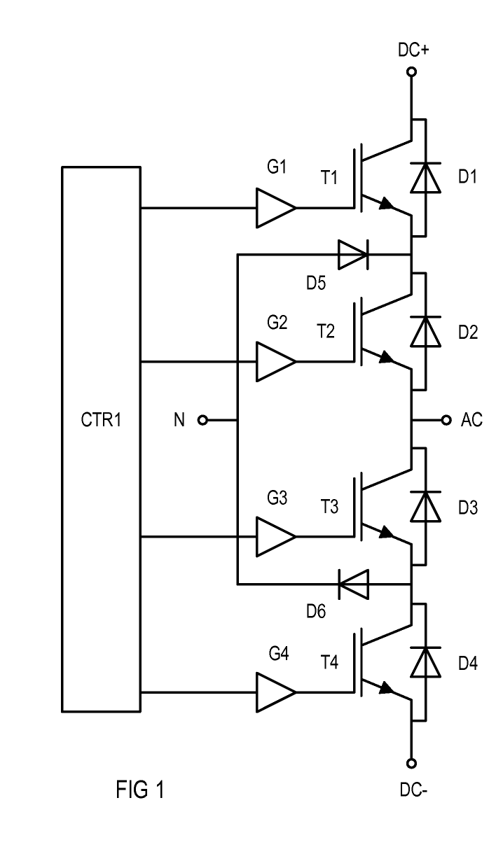

In a three-level driver circuit for an inverter half-bridge, as illustrated in FIG. 1, the DC power supply has three voltage levels: positive level DC+, neutral level N and negative level DC−. The three-level AC drive includes an output inverter half-bridge, which has four switches T1-T4 in series. An alternating output voltage AC is derived from a middle point between switches T2 and T3. The top two series-connected switches T1 and T2 are connected to the positive bus DC+ and behave like one switch, but they cannot be turned on and off at the same time. The switch at the very top, switch T1, is turned on after and/or turned off before the other switch in the top pair, switch T2. The bottom two switches T3 and T4 are connected to the negative bus DC−. The switch at the very bottom, switch T4, has to be turned on after and/or turned off before the other switch of the bottom pair, switch T3. The switches are controlled by signals from switch controller CTR1 applied via gate drivers G1-G4. Switch delay times must be taken into consideration to prevent short-circuiting when dimensioning the switching constellations of switches T1-T4.

If the converter of FIG. 1 utilizes IGBTs as switches T1-T4, each excitation control signal is a voltage applied between a gate and an emitter of a respective IGBT. If the switches are FETs, each excitation control signal is a voltage applied between a gate and a source of a respective FET. If the switches are BJTs, each excitation control signal is a current applied between a base and an emitter of a respective BJT. In the converter of FIG. 1, diodes D1-D4 are anti-parallel to the emitter collector (load) paths of the IGBTs utilized as switches T1-T4. Diode D5 is connected between the neutral point N and the midpoint between switches T1 and T2, and diode D6 is connected between the neutral point N and the midpoint between switches T3 and T4. Both diodes D5 and D6 clamp the respective midpoints to the neutral point when one of switches T2 or T3 is in a conductive state and the respective other switch T1 or T4 is in a non-conductive state.

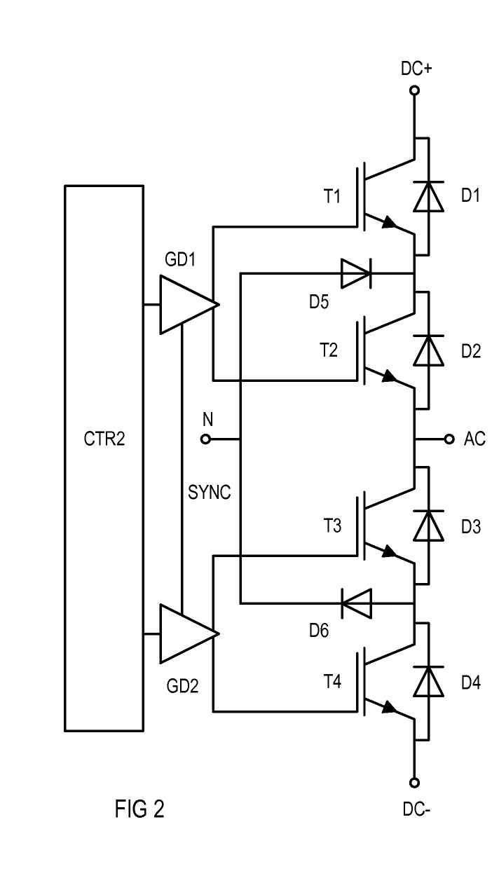

Compared to the drive circuit of FIG. 1, a three-level driver circuit with an inverter half-bridge, as shown in FIG. 2, has two dual output drivers GD1 and GD2 instead of single output drivers G1-G4. Dual output drivers GD1 and GD2 provide two signals from a single input signal, i.e., one of the two-level signals provided by switch controller CTR2, to control the respective switch pair T1, T2 or T3, T4. Synchronization signal SYNC is swapped between dual output drivers GD1 and GD2 to address slightly different signal processing behavior between the drivers, which may cause both legs of the half-bridge to switch on at the same time. Synchronization signal SYNC may allow for one driver that switches on the respective leg to disable the other driver in order to prevent the other leg from switching on and vice versa. Furthermore, a delay time may be established by way of synchronization signal SYNC when toggling the legs to ensure that a maximum of one leg is switched on at a time.

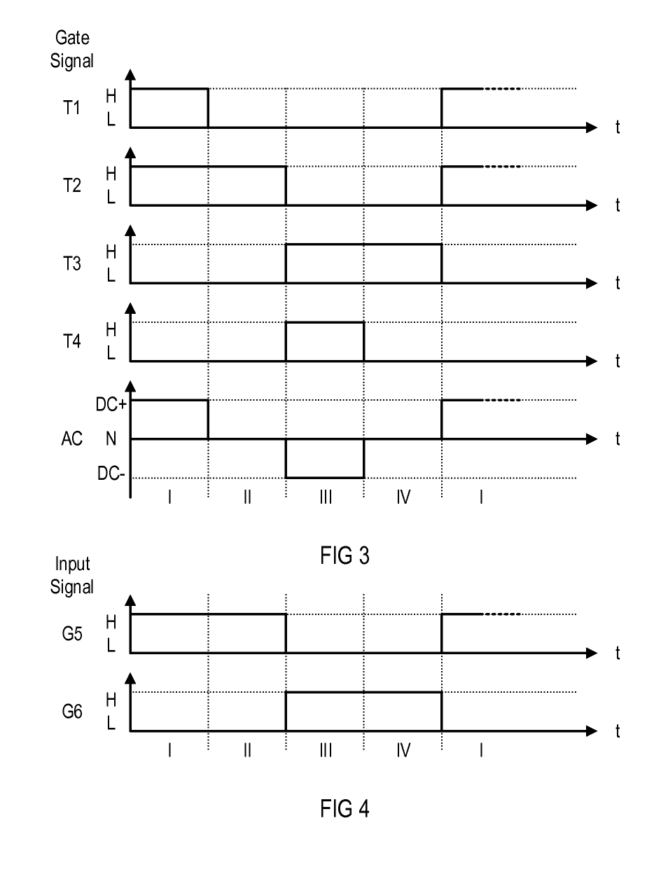

In the three-level inverter half-bridge of FIG. 2, switches T1-T4 are configured and controlled to assume one of the following states during four different phases I-IV over time t, as illustrated in FIG. 3:

I) T1 and T2 are on, T3 and T4 are off;

II) T2 is on, T1, T3 and T4 are off;

III) T1 and T2 are off, T3 and T4 are on;

IV) T3 is on, T1, T2 and T4 are off.

As IGBTs are utilized as switches T1-T4 in the inverter half-bridge of FIG. 2, “on” means that the emitter collector (load) path is conductive and the corresponding control signal is on a high level H at the gate of the respective IGBT and “off” means that the emitter collector (load) path is non-conductive and the corresponding control signal is on a low level L. This switching scheme results in an output voltage AC that is positive (DC+) in phase I, negative (DC−) in phase III and neutral (N) in phases II and IV. In the present case, the input signals of the dual output drivers GD1 and GD2 may be identical to the control signals of switches T2 and T3, as shown in FIG. 4, but any other relationship between input and output signals may be applicable as well, provided both input signals to dual output drivers GD1 and GD2 exhibit a 180-degree phase shift (with a delay at switching edges) relative to each other.

Thus, the pair of (e.g., pulse-width-modulated) two-level driving signals from controller CTR2 are processed in the two dual output drivers GD1 and GD2 to control the three-level inverter half-bridge. This is accomplished by breaking apart a two-level input signal in a driver into two time-coordinated three-level control output signals required by the inverter half-bridge, taking into consideration the position of the respective switch inside the multi-level inverter bridge and a switch's turn-on and/or turn-off delay times. Although switches T1 and T2 or T3 and T4 are switched on at the same time in the present example, they may be switched on at separate times or switched off at the same time instead of being switched off at separate times, as shown, provided the overlap of both pulses is less than 100% and the shorter pulse occurs during the occurrence of the longer pulse.

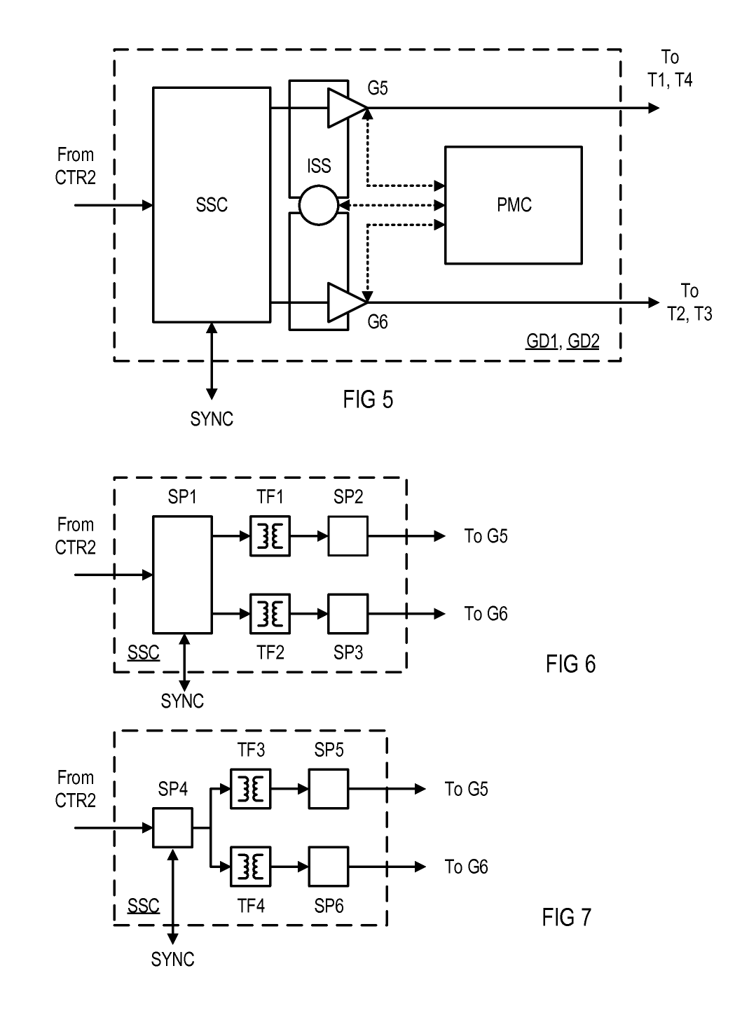

Referring to FIG. 5, dual output drivers GD1 and GD2 may include protection and monitoring circuit PMC, monitoring, for example, the output voltage or the output current of dual output drivers GD1 and GD2 and controlling isolated supply voltage source ISS for internal single output gate drivers G5 and G6 to prevent damage due to overvoltage and/or overcurrent and/or over-temperature. Protection and monitoring circuit PMC may also monitor voltage across a respective switch or include an overload condition detecting circuit, detecting an overload condition by comparing the monitored voltage or current of the respective switch in the on-state with a threshold level (both not shown). Dual output drivers GD1 and GD2 may further include signal splitting circuit SSC that generates two control signals for one leg of a three-level inverter half-bridge from one of the two two-level control signals provided by switch controller CTR2. Signal splitting circuit SSC may also form an interface for synchronization signal SYNC.

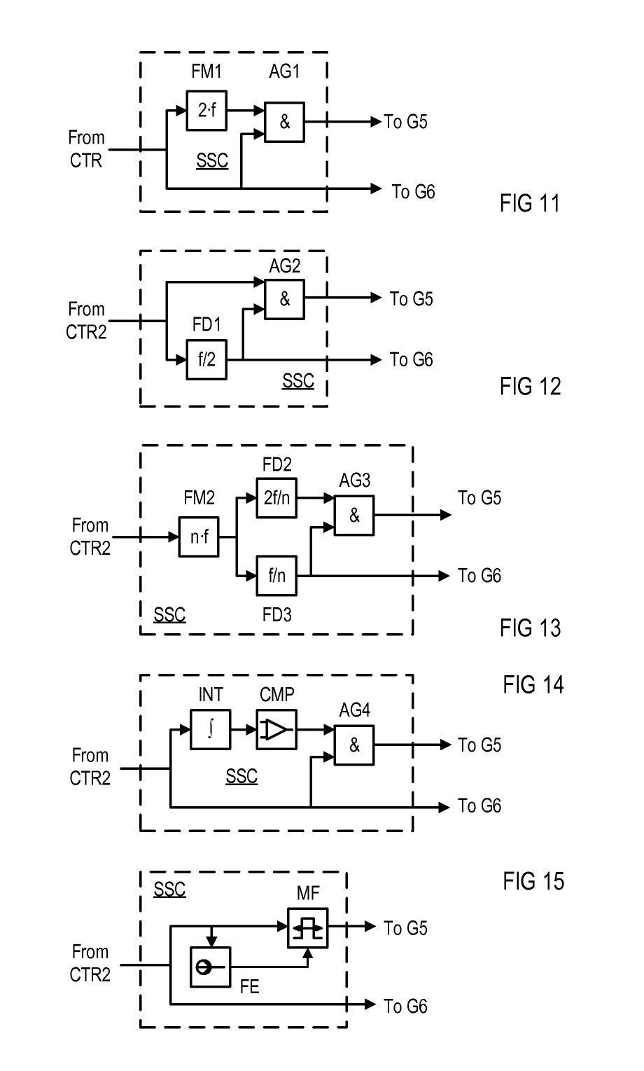

A variety of examples of signal splitting circuit SSC, in view of providing galvanically isolated control for the inverter half-bridge, are described below in connection with FIGS. 6-10. Signal processing circuits SP1-SP14 utilized therein may include any type of adequate circuitry such as analog, digital, mixed-signal, microcontroller, signal processor or field programmable gate array (FPGA) circuitry and all kinds of memory and storage circuitry. FIGS. 11-15 illustrate typical signal processing structures in which any galvanically isolated signal paths have been omitted for illustration purposes. However, the structures shown in FIGS. 6-10 and 11-15 can be merged so that signal processing circuits SP1-SP14 of FIGS. 6-10 may represent elements described in connection with the structures shown in FIGS. 11-15.

In the signal splitting circuit SSC shown in FIG. 6, signal processing circuit SP1 receives a two-level control signal from switch controller CTR2 as an input and splits the single two-level input signal into two three-level output signals or a corresponding precursor signal, which are then transmitted via galvanically isolated transfer circuits TF1 and TF2, e.g., transformers, capacitive couplers, optoelectronic couplers or the like, to further signal processing units SP2 and SP3, respectively, for further processing and outputting the control signals via gate drivers G5 and G6 to the respective pair of switches T1, T2 or T3, T4. Signal processing circuit SP1 may also be connected to synchronization signal SYNC.

Referring to FIG. 7, signal processing circuit SP4 receives a two-level control signal from switch controller CTR2 as an input and distributes this signal via two galvanically isolated transfer circuits TF3 and TF4 to further signal processing units SP5 and SP6, respectively, for further processing and outputting the control signals via gate drivers G5 and G6 to the respective pair of switches T1, T2 or T3, T4. Signal processing circuit SP4 may also be connected to synchronization signal SYNC.

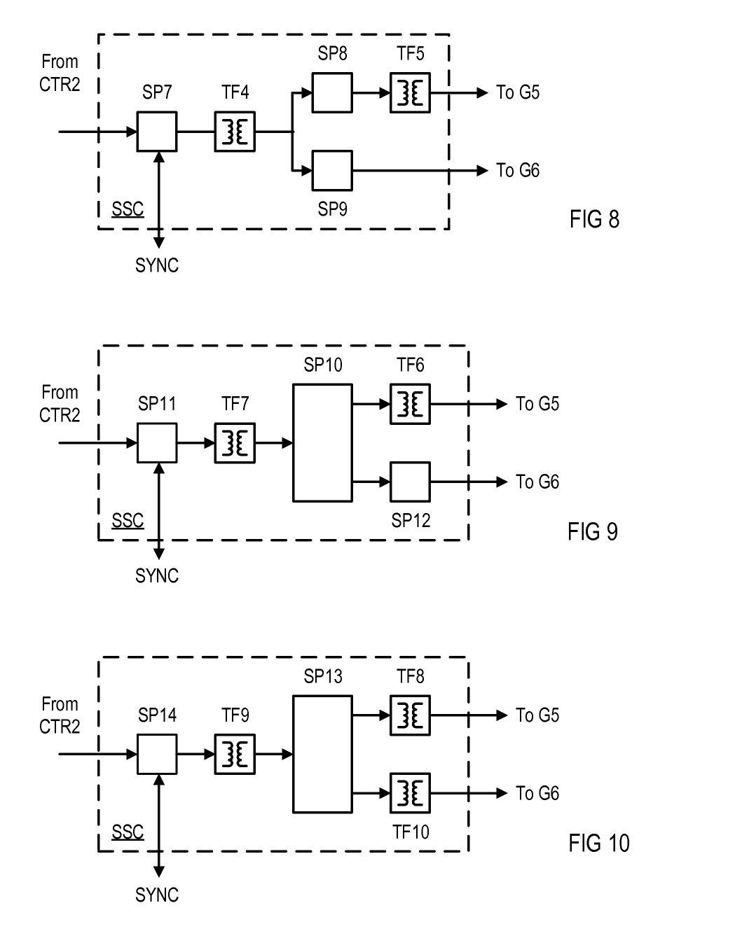

FIG. 8 illustrates signal splitting circuit SSC in which two signal processing circuits SP8 and SP9 receive the two-level control signal from switch controller CTR2 as inputs via signal processing circuit SP7 and a galvanically isolated transfer circuit TF5 to generate two three-level signals, one of which is transmitted to driver G5 via a galvanically isolated transfer circuit TF3 and the other is directly transmitted to driver G6. Signal processing circuit SP7 may also be connected to synchronization signal SYNC.

FIG. 9 illustrates signal splitting circuit SSC in which signal processing circuit SP10 receives the two-level control signal from switch controller CTR2 as an input via signal processing circuit SP11 and a galvanically isolated transfer circuit TF5 to generate two three-level signals, one of which is transmitted to driver G5 via a galvanically isolated transfer circuit TF6 and the other is transmitted to driver G6 via signal processing circuit SP12. Signal processing circuit SP11 may also be connected to synchronization signal SYNC.

FIG. 10 illustrates signal splitting circuit SSC in which signal processing circuit SP13 receives the two-level control signal from switch controller CTR2 as an input via signal processing circuit SP14 and a galvanically isolated transfer circuit TF9 to generate two three-level signals, one of which is transmitted to driver G5 via a galvanically isolated transfer circuit TF8 and the other is transmitted to driver G6 via a galvanically isolated transfer circuit TF10. Signal processing circuit SP14 may also form an interface for synchronization signal SYNC.

Referring to FIG. 11, signal splitting circuit SSC may have a signal processing structure in which the two-level control signal from switch controller CTR2 is both bypassed to driver G6 and supplied to frequency multiplier FM1, which doubles the frequency (f) of the two-level control signal from switch controller CTR2 in the present example and may also modify the amplitude of the two-level control signal. The output of frequency multiplier FM1 and the two-level control signal from switch controller CTR2 are supplied to AND gate AG1, whose output signal is supplied to driver G5. Instead of AND gate AG1, any other type of gate or logical circuit that provides an appropriate logical conjunction may be used. Frequency multiplier FM1 may include a phase lock loop circuit, a phase shifter with multiplier, etc.

A similar approach to the circuit of FIG. 11 is utilized in the exemplary signal splitting circuit SSC of FIG. 12. The two-level control signal from switch controller CTR2 is both supplied to an input of AND gate AG1 and to frequency divider FD1, which divides the frequency of the two-level control signal from switch controller CTR2 by two in the present example and may also modify the amplitude of the two-level control signal. The outputs of AND gate AG2 and frequency divider FD1 are supplied to drivers G5 and G6, respectively. Instead of AND gate AG1, any other type of gate or logical circuit that provides an appropriate logical conjunction may be used.

In the exemplary signal splitting circuit SSC of FIG. 13, the two-level control signal from switch controller CTR2 is supplied to frequency multiplier FM2, which increases the frequency of the two-level control signal from switch controller CTR2 by n in the present example. The output signal of frequency multiplier FM1 is supplied to both frequency divider FD2, which divides the frequency of its input signal by n/2, and frequency divider FD3, which divides the frequency of its input signal by n. The output signals of frequency dividers FD3 and FD4 are supplied to AND gate AG3 connected downstream of frequency dividers FD3 and FD4. The outputs of AND gate AG3 and frequency divider FD3 are supplied to drivers G5 and G6, respectively. In signal splitting circuit SSC of FIG. 13, frequency multiplier FM2 is particularly applicable when no synchronous output signal with regard to its input signal is mandatory.

Referring to FIG. 14, signal splitting circuit SSC may have a signal processing structure in which the two-level control signal from switch controller CTR2 is both bypassed to driver G6 and supplied to a phase shifter including integrator INT and comparator CMP. The phase shifter is configured in the present example to provide the two-level control signal from switch controller CTR2 phase shifted by 90 degrees, but any other phase shift is applicable as well. The output signal of comparator CMP and the two-level control signal from switch controller CTR2 are supplied to AND gate AG4, whose output signal is supplied to driver G5.

In the exemplary signal splitting circuit SSC of FIG. 15, the two-level control signal from switch controller CTR2 is both bypassed to driver G6 and supplied to frequency evaluation circuit FE and a controllable monostable flip-flop MF, whose output signal is supplied to driver G5. Monostable flip-flop MF is controlled by frequency evaluation circuit FE such that with increasing/decreasing frequency of the two-level control signal from switch controller CTR2, the pulse duration increases/decreases, in which the pulse duration is in any event smaller than the half period of the two-level control signal from switch controller CTR2. Instead of frequency evaluation circuit FE, a pulse duration estimation circuit (not shown) or a fixed pulse duration may be used.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A driver circuit for a pair of switches in a leg of a three-level inverter half-bridge, comprising:
a driver input configured to receive a two-level input signal that comprises at least one given pulse with a given pulse duration during which the input signal takes on one of the two levels;
a first driver output configured to provide a control signal for one switch of the pair of switches;
a second driver output configured to provide a control signal for the other switch of the pair of switches;
a signal processing circuit that has one input branch, and first and second output branches in which:
the input branch is coupled with the driver input, the first output branch is coupled with the first driver output and the second output branch is coupled with the second driver output;
the first output branch is configured to provide a two-level output signal that comprises a first pulse with a first pulse duration during which the input signal takes on one of the two levels;
the second output branch is configured to provide a two-level output signal that comprises a second pulse with a second pulse duration during which the second output signal takes on one of the two levels;
the first length is smaller than or equal to the given length and the second length is smaller than the first length; and
the second pulse occurs during the occurrence of the first pulse.

2. The driver circuit of claim 1, wherein at least one of the input path, the first output path and the second output path comprises a galvanically isolating coupler.

3. The driver circuit of claim 1, wherein each output path comprises an output driver coupled to the respective driver output and to a power supply source configured to provide one or more supply voltages for the output drivers.

4. The driver circuit of claim 3, wherein the power supply source is configured to provide one or more galvanically isolated supply voltages.

5. The driver circuit of claim 3, further comprising protection circuitry configured to evaluate at least one of output current, output voltage and temperature of the drivers and reduce or switch off the output voltage of the power supply source.

6. The driver circuit of claim 1, wherein the signal processing circuit is configured to delay or phase shift the first pulse and to logically AND the first pulse with the delayed or phase-shifted first pulse to provide the second pulse.

7. The driver circuit of claim 1, wherein the second output path comprises a monostable flip-flop that is configured to generate a second pulse with a second pulse duration that is shorter than the first pulse duration.

8. The driver circuit of claim 7, wherein the monostable flip-flop is configured to provide a second pulse with a controllable second pulse duration.

9. The driver circuit of claim 1, wherein:
the input signal is a pulse sequence with multiple subsequent pulses at a given frequency;
the signal processing circuit is configured to provide two output pulse sequences at different frequencies from each other on the output paths;
the output sequence with the lower frequency forms the first output of the gate driver circuit; and
the signal processing circuit is further configured to logically AND the two output sequences to provide the second output of the gate driver circuit.

10. The driver circuit of claim 9, wherein the signal processing circuit further comprises a frequency multiplier connected in the input path.

11. A three-level inverter half-bridge comprising a pair of transistors in each half-bridge leg and two driver circuits connected to the control inputs of the pair of transistors, wherein:
each pair of transistors comprises a series connection of the load paths of an inner switch connected to an inverter output and an outer switch connected to an inverter supply line; and
each of the driver circuits comprises:
a driver input configured to receive a two-level input signal that comprises at least one given pulse with a given pulse duration during which the input signal takes on one of the two levels;
a first driver output configured to provide a control signal for the outer switch of the pair of switches;
a second driver output configured to provide a control signal for the inner switch of the pair of switches;
a signal processing circuit that has one input branch, and first and second output branches, wherein:
the input branch is coupled with the driver input, the first output branch is coupled with the first driver output and the second output branch is coupled with the second driver output;
the first output branch is configured to provide a two-level output signal that comprises a first pulse with a first pulse duration during which the input signal takes on one of the two levels;
the second output branch is configured to provide a two-level output signal that comprises a second pulse of a second pulse duration during which the second output signal takes on one of the two levels;
the first length is smaller than or equal to the given length and the second length is smaller than the first length; and
the second pulse occurs during the occurrence of the first pulse.

12. The three-level inverter half-bridge of claim 11, wherein at least one of the input path, the first output path and the second output path comprises a galvanically isolating coupler.

13. The three-level inverter half-bridge of claim 11, wherein each output path comprises an output driver coupled to the respective driver output and to a power supply source configured to provide one or more supply voltages for the output drivers.

14. The three-level inverter half-bridge of claim 13, wherein the power supply source is configured to provide one or more galvanically isolated supply voltages.

15. The three-level inverter half-bridge of claim 13, further comprising protection circuitry configured to evaluate at least one of output current, output voltage or temperature of the drivers and reduce or switch off the output voltage of the power supply source.

16. The three-level inverter half-bridge of claim 11, wherein the signal processing circuit is configured to delay or phase shift the first pulse and to logically AND the first pulse with the delayed or phase-shifted first pulse to provide the second pulse.

17. The three-level inverter half-bridge of claim 11, wherein the second output path comprises a monostable flip-flop configured to generate a second pulse with a second pulse duration that is shorter than the first pulse duration.

18. The three-level inverter half-bridge of claim 17, wherein the monostable flip-flop is configured to provide a second pulse with a controllable second pulse duration.

19. The three-level inverter half-bridge of claim 11, wherein:
the input signal is a pulse sequence with multiple subsequent pulses at a given frequency;
the signal processing circuit is configured to provide two output pulse sequences at different frequencies from each other on the output paths;
the output sequence with the lower frequency forms the first output of the gate driver circuit; and
the signal processing circuit is further configured to logically AND the two output sequences to provide the second output of the gate driver circuit.

20. The three-level inverter half-bridge of claim 19, wherein the signal processing circuit further comprises a frequency multiplier connected in the input path.

21. The three-level inverter half-bridge of claim 19, wherein the driver circuits for the half-bridge legs are synchronized by a synchronization signal such that only one leg of the half-bridge is switched on at a time.
